(19) United States
(12) Patent Application Publication
(10) Pub. No.: US 2026/0248189 A1
(43) Pub. Date: Aug. 27, 2026

(54) AEROSOL GENERATING DEVICE

(71) Applicant: SHENZHEN SMOORE TECHNOLOGY LIMITED, Shenzhen (CN)

(72) Inventors: Min WANG, Shenzhen (CN); Chen LAN, Shenzhen (CN); Fengwen LU, Shenzhen (CN); Weidong ZHOU, Shenzhen (CN)

(73) Assignee: SHENZHEN SMOORE TECHNOLOGY LIMITED, Shenzhen (CN)

(21) Appl. No.: 19/546,819

(22) Filed: Feb. 23, 2026

(30) Foreign Application Priority Data
Feb. 27, 2025 (CN) 202520325126.X

(51) Int. Cl. A24F 40/46; A24F 40/10; A24F 40/42; H05B 3/06

(52) U.S. Cl. CPC A24F 40/46; A24F 40/10; A24F 40/42; H05B 3/06

(57) ABSTRACT

An aerosol generating device including a liquid storage assembly, an atomization core, and a fixing bracket is provided. The liquid storage assembly is formed with a liquid storage cavity, and the liquid storage cavity is configured to store an aerosol generating substrate. The atomization core atomizes the aerosol generating substrate to generate an aerosol. The fixing bracket includes a spring contact, the atomization core has a thickness direction, and one side of the spring contact in the thickness direction is in stop engagement with the atomization core.

### RELATED APPLICATIONS

This application claims priority to Chinese Patent Application No. 202520325126.X, filed on Feb. 27, 2025. The entire disclosure of the prior application is hereby incorporated by reference.

### TECHNICAL FIELD

This application relates to the technical field of atomization, including to an aerosol generating device.

### BACKGROUND

This section is intended to provide a background or context for implementations of this disclosure. Descriptions herein are not admitted to be the existing technology by virtue of their inclusion in this section.

Typically, an aerosol generating device includes an atomization core, and the atomization core is configured to atomize an aerosol generating substrate to generate an aerosol. In the related technology, the atomization core needs to be fixed, to reduce a risk of shifting of the atomization core in use.

### SUMMARY

In view of this, examples of this disclosure are expected to provide an aerosol generating device, to reduce a number of parts required for fixing an atomization core.

An aspect of this disclosure provides an aerosol generating device, including:
a liquid storage assembly, formed with a liquid storage cavity, where the liquid storage cavity is configured to store an aerosol generating substrate;
an atomization core, where the atomization core atomizes the aerosol generating substrate to generate an aerosol; and
a fixing bracket, including a spring contact, where the atomization core has a thickness direction, and one side of the spring contact in the thickness direction is in stop engagement with the atomization core.

In an aspect, the spring contact is formed with a protrusion facing the atomization core, and the protrusion abuts against the atomization core.

In an aspect, the fixing bracket includes a stopping structure, the stopping structure is in stop engagement with the atomization core, and at least a part of the stopping structure and the spring contact are respectively located on different sides of the atomization core.

In an aspect, the aerosol generating device includes a conductive member, and the conductive member is electrically connected to the fixing bracket.

In an aspect, the aerosol generating device includes two conductive members and two fixing brackets, the two conductive members are electrically connected to the two fixing brackets, respectively, and the atomization core is located in a limiting space of the two fixing brackets.

In an aspect, the atomization core includes a body and a heating element, at least a part of the heating element is disposed on a surface of the body, and the spring contact abuts against the heating element.

In an aspect, the aerosol generating device includes a conductive member, the conductive member and the spring contact jointly define a limiting space, at least a part of the atomization core is located in the limiting space, and the spring contact and the conductive member respectively abut against two opposite ends of the atomization core in a thickness direction.

In an aspect, the aerosol generating device includes two fixing brackets, the two fixing brackets are disposed at an interval, the conductive member is located between the two fixing brackets to define the two limiting spaces, and at least one atomization core is disposed in each limiting space.

In an aspect, the atomization core includes a body and a heating element, at least a part of the heating element is disposed on a surface of the body, and the conductive member abuts against the heating element.

In an aspect, the aerosol generating device includes an insulating member, and the atomization core is supported above the insulating member.

According to the aerosol generating device provided in examples of this disclosure, the elastic force of the spring contact is applied to the atomization core, which can improve connection stability between the atomization core and the fixing bracket and reduce assembly/disassembly difficulty. In addition, in this disclosure, the atomization core can be fixed through one fixing bracket, which is convenient and fast, can simplify assembly of the atomization core, reduce a number of required parts, reduce production costs, and improve production efficiency.

### BRIEF DESCRIPTION OF THE DRAWINGS

FIG. 1 is a schematic structural diagram of an aerosol generating device according to an aspect of this disclosure;

FIG. 2 is a schematic sectional view of a position a-a in FIG. 1;

FIG. 3 is a schematic structural diagram of a fixing bracket according to an aspect of this disclosure;

FIG. 4 is a schematic structural diagram of assembly of a fixing bracket, a conductive member, and an atomization core according to an aspect of this disclosure;

FIG. 5 is a schematic structural diagram of the structure shown in FIG. 4 from another perspective;

FIG. 6 is a schematic structural diagram of the structure shown in FIG. 4 from still another perspective;

FIG. 7 is a schematic sectional diagram of an aerosol generating device according to an aspect of this disclosure;

FIG. 8 is a schematic structural diagram of assembly of a fixing bracket, a conductive member, an atomization core, and an insulating member according to an aspect of this disclosure;

FIG. 9 is a schematic structural diagram of the structure shown in FIG. 8 from another perspective;

FIG. 10 is a schematic structural diagram of a fixing bracket according to an aspect of this disclosure; and

FIG. 11 is a schematic structural diagram of a liquid storage housing according to an aspect of this disclosure.

### DESCRIPTIONS OF REFERENCE NUMERALS

100: aerosol generating device;
1: liquid storage assembly; 1a: liquid storage cavity; 1b: atomization channel; 11: buffer structure; 12: liquid storage housing; 121: liquid storage tube; 13: sealing base;
2: atomization core; 21: body; 22: heating element;
3: fixing bracket; 3a: limiting space; 3b: access opening; 30: stopping structure; 31: spring contact; 311: protrusion; 32: stopping member; 321: limiting portion; 33: limiting member; 34: carrier plate; 34a: avoidance notch;
4: conductive member;
5: insulating member; 51: limiting post;
6: housing assembly; 6a: inhalation channel; 61: mouthpiece; and
7: cell assembly.

### DETAILED DESCRIPTION

The following describes implementations of this disclosure in further detail with reference to the accompanying drawings and examples. The following examples are used for describing this disclosure rather than limiting the scope of this disclosure.

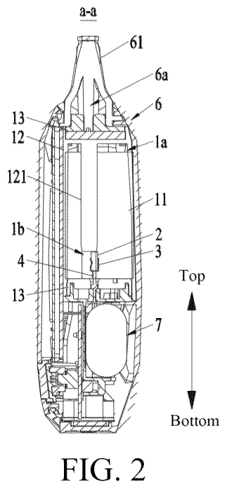

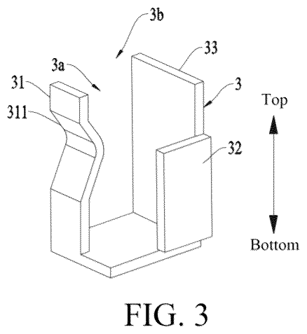

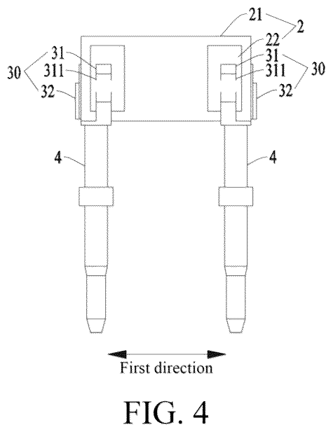

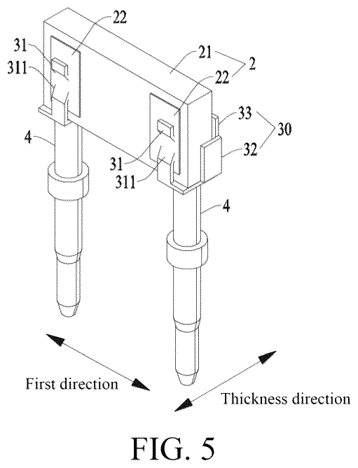

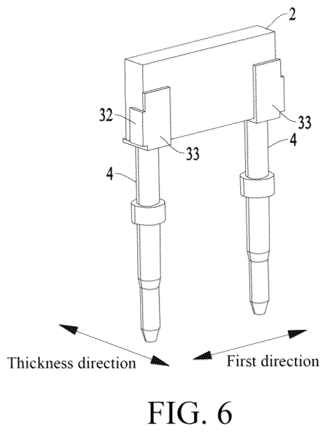

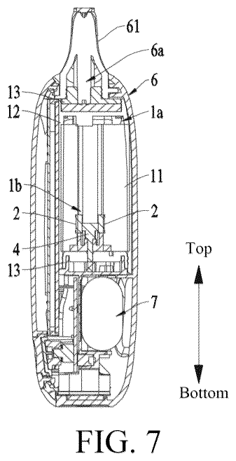

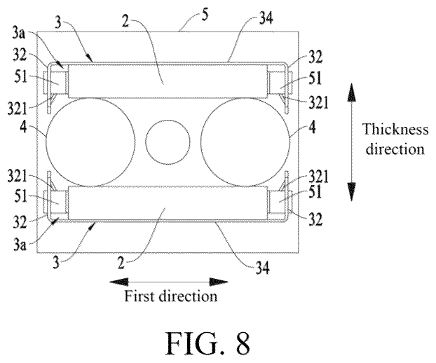

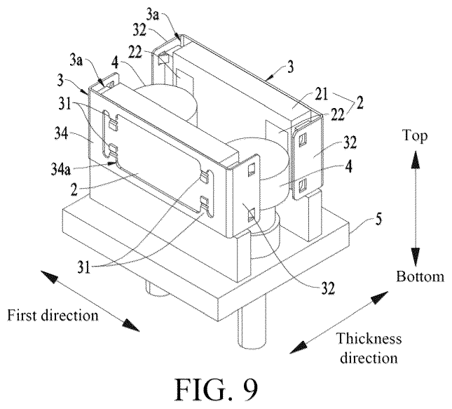

In descriptions of the examples of this disclosure, an orientation or positional relationship of a “thickness direction” is an orientation or positional relationship shown in FIG. 5, FIG. 6, FIG. 8, and FIG. 9; an orientation or positional relationship of a “first direction” is an orientation or positional relationship shown in FIG. 4 to FIG. 6, FIG. 8, and FIG. 9; and an orientation or positional relationship of a “top-bottom” direction is an orientation or positional relationship shown in FIG. 2, FIG. 3, FIG. 7, and FIG. 9. It should be understood that these orientation terms are only for the convenience of describing the examples of this disclosure and simplifying the description, and do not indicate or imply that a referred device or element needs to have a specific orientation, needs to be constructed and operated in a specific orientation. Therefore, these orientation terms should not be construed as limiting the examples of this disclosure.

Various specific technical features and examples described in specific implementations can be combined in any suitable manner without contradiction. For example, different implementations can be formed by combining different specific technical features/examples. To avoid unnecessary repetition, various possible combinations of the various specific technical features/examples in this disclosure are not be described separately. In addition, the term “first” is used for descriptive purposes only and should not be construed as indicating or implying relative importance. The following describes this disclosure in further detail with reference to the accompanying drawings and specific examples.

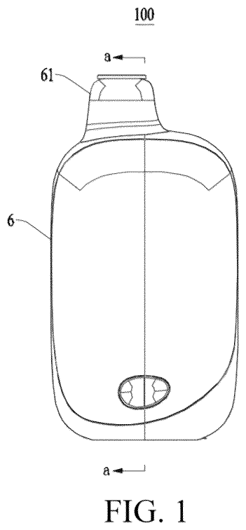

Refer to FIG. 1 to FIG. 11. Examples of this disclosure provide an aerosol generating device 100, including a liquid storage assembly 1, an atomization core 2, and a fixing bracket 3. The liquid storage assembly 1 is formed with a liquid storage cavity 1a, and the liquid storage cavity 1a is configured to store an aerosol generating substrate. The atomization core 2 atomizes the aerosol generating substrate to generate an aerosol. The fixing bracket 3 includes a spring contact 31, the atomization core 2 has a thickness direction, and one side of the spring contact 31 in the thickness direction is in stop engagement with the atomization core 2.

The atomization core 2 is disposed in the liquid storage cavity 1a, and the atomization core 2 can be in contact with the aerosol generating substrate and atomize the aerosol generating substrate in a manner, such as heating, to generate an aerosol for user inhalation.

Refer to FIG. 3. For example, the fixing bracket 3 includes a limiting space 3a, at least a part of the atomization core 2 is located in the limiting space 3a, and the limiting space 3a may be configured to limit movement of the atomization core 2, to fix the atomization core 2. For example, a shape of the part, located in the limiting space 3a, of the atomization core 2 is approximately the same as that of the limiting space 3a. In this way, the surface of the atomization core 2 closely fits the surface of the fixing bracket 3, and a minimal gap is reserved between the surface of the atomization core and the surface of the fixing bracket, which can prevent the atomization core 2 from shaking or shifting in the limiting space 3a.

That at least a part of the atomization core 2 is located in the limiting space 3a refers to that: a part of the atomization core 2 may be located in the limiting space 3a, or the entire atomization core 2 may be located in the limiting space 3a.

Refer to FIG. 3. For example, the fixing bracket 3 is formed with an access opening 3b that communicates with the limiting space 3a, and the atomization core 2 can enter or be removed from the limiting space 3a through the access opening 3b. This facilitates assembly of the atomization core 2.

The spring contact 31 is a structure capable of undergoing elastic deformation, for example, may be a structure made of an elastic material. The elastic material refers to a material that can undergo elastic deformation, such as bending, folding, twisting, compression, and/or stretching, and can recover from the deformation within a particular limit.

The stop engagement between the spring contact 31 and the atomization core 2 means that: the atomization core 2 and the spring contact 31 are in contact with each other (in a stopping manner) during assembly, to achieve precise positioning and fitting. In this way, the elastic force of the spring contact 31 is applied to the atomization core 2, and the spring contact 31 abuts against the atomization core 2, which can improve connection stability between the atomization core 2 and the fixing bracket 3.

According to the aerosol generating device provided in the examples of this disclosure, the spring contact 31 is in stop engagement with the atomization core 2, and the elastic force of the spring contact 31 is applied to the atomization core 2, which can improve connection stability between the atomization core 2 and the fixing bracket 3 and reduce assembly/disassembly difficulty. In addition, in this disclosure, the atomization core 2 can be fixed through one fixing bracket 3, which is convenient and fast, can simplify assembly of the atomization core 2, reduce a number of required parts, reduce production costs, and improve production efficiency.

In an aspect, the fixing bracket 3 is an integrally formed structure. The integrally formed structure refers to a structure manufactured by an integral forming process. This can reduce assembly steps of the fixing bracket 3 and improve stability of the fixing bracket 3.

In an aspect, the fixing bracket 3 may alternatively be a split structure. To be specific, the fixing bracket 3 may be assembled and formed by combining two or more parts.

In an aspect, the fixing bracket 3 may be a structure made of an elastic material. For example, the fixing bracket 3 may be made of a metal material. In this way, the fixing bracket 3 is in flexible contact with the atomization core 2. The elasticity of the fixing bracket 3 can reduce the force transmitted to the atomization core 2, thereby providing good protection for the atomization core 2.

Refer to FIG. 2 and FIG. 7. In an aspect, the liquid storage assembly 1 includes a buffer structure 11 disposed in the liquid storage cavity 1a, and the buffer structure 11 can absorb and release the aerosol generating substrate.

In this disclosure, the aerosol generating substrate is in a liquid state, and the buffer structure 11 can absorb the aerosol generating substrate. In this way, the buffer structure 11 can lock the liquid, and can prevent the aerosol generating substrate from seeping out of the liquid storage cavity 1a, thereby reducing a risk of liquid leakage. In a process in which a user inhales an aerosol, the aerosol generating substrate absorbed by the buffer structure 11 is released to the atomization core 2, and the atomization core 2 atomizes the liquid aerosol generating substrate to generate an aerosol.

In an aspect, the buffer structure 11 may be a flexible structure having a plurality of pores, and the buffer structure 11 absorbs and releases the aerosol generating substrate through capillary action.

For example, a material of the buffer structure 11 includes one or more of non-woven fabric, linen, and wood pulp cotton. For example, the buffer structure 11 may be made of wood pulp cotton.

Refer to FIG. 2. In an aspect, at least a part of the buffer structure 11 is located on the side, away from the spring contact 31, of the atomization core 2, and the elastic force of the spring contact 31 enables the atomization core 2 to abut closely against the buffer structure 11. In this way, the surface of the atomization core 2 can closely fit the surface of the buffer structure 11, and the aerosol generating substrate can be directly guided from the buffer structure 11 to the atomization core 2, thereby shortening a transmission path of the aerosol generating substrate and improving atomization efficiency. In addition, heat energy utilization of the atomization core 2 is effectively improved, and energy loss is reduced.

Refer to FIG. 3 to FIG. 5. In an aspect, the spring contact 31 is formed with a protrusion 311 facing the atomization core 2, and the protrusion 311 abuts against the atomization core 2. For example, the surface, facing the atomization core 2, of the protrusion 311 may be a smooth convex arc surface. In this way, the protrusion 311 may increase a contact area between the spring contact 31 and the atomization core 2, thereby increasing the elastic force applied by the spring contact 31 to the atomization core 2, and improving stability of the atomization core 2. In addition, the spring contact 31 is in flexible contact with the atomization core 2. In this way, the protrusion 311 can be deformed, bent, or the like according to the outer surface of the atomization core 2, which ensures stability of the atomization core 2 and avoids damage to an inner structure of the atomization core 2. This enables the atomization core 2 to maintain good permeability to the aerosol generating substrate.

Refer to FIG. 4 and FIG. 5. In an aspect, the fixing bracket 3 includes a stopping structure 30, the stopping structure is in stop engagement with the atomization core 2, and at least a part of the stopping structure 30 and the spring contact 31 are respectively located on different sides of the atomization core 2. In this way, the stopping structure 30 and the spring contact 31 can respectively limit movement of the atomization core 2 in different directions, to enhance stability of the atomization core 2.

That at least a part of the stopping structure 30 and the spring contact 31 are respectively located on different sides of the atomization core 2 means that: a part of the stopping structure 30 and the spring contact 31 may be respectively located on different sides of the atomization core 2, or the entire stopping structure 30 and the spring contact 31 may be respectively located on different sides of the atomization core 2.

Refer to FIG. 4 and FIG. 5. In an aspect, the stopping structure 30 includes a stopping member 32, the spring contact 31 is disposed on at least one side of the atomization core 2 in the thickness direction, the stopping member 32 is disposed on at least one side of the atomization core 2 in a first direction, and the thickness direction intersects the first direction.

That the spring contact 31 is disposed on at least one side of the atomization core 2 in the thickness direction means that: the spring contact 31 may be disposed on one side of the atomization core 2 in the thickness direction, or the spring contacts 31 may be disposed on both sides of the atomization core 2 in the thickness direction.

That the stopping member 32 is disposed on at least one side of the atomization core 2 in the first direction means that: the stopping member 32 may be disposed on one side of the atomization core 2 in the first direction, or the stopping members 32 may be disposed on both sides of the atomization core 2 in the first direction.

In this aspect, the spring contact 31 and the stopping member 32 are respectively located on different sides of the atomization core 2. The spring contact 31 can limit movement of the atomization core 2 in the thickness direction, and the stopping member 32 can limit movement of the atomization core 2 in the first direction, which can further improve stability of the atomization core 2.

It should be noted that the intersection between the thickness direction and the first direction may be oblique or perpendicular.

In an aspect, the spring contacts 31 are disposed on two opposite sides of the atomization core 2 in the thickness direction, and the stopping member 32 is disposed on at least one side of the atomization core 2 in the first direction. In some other aspects, the spring contact 31 is disposed on at least one side of the atomization core 2 in the thickness direction, and the stopping members 32 are disposed on two opposite sides of the atomization core 2 in the first direction. In some other aspects, the spring contacts 31 are disposed on two opposite ends of the atomization core 2 in the thickness direction, and the stopping members 32 are disposed on two opposite ends of the atomization core 2 in the first direction.

In an aspect, the stopping member 32 is approximately in a plate-like shape, which can increase a contact area between the stopping member 32 and the atomization core 2 and further improve stability of the atomization core 2.

Refer to FIG. 3 and FIG. 6. In an aspect, the stopping structure 30 includes a limiting member 33, the spring contact 31 and the limiting member 33 jointly define the limiting space 3a, and the spring contact 31 and the limiting member 33 respectively abut against two opposite ends of the atomization core 2.

Refer to FIG. 3 and FIG. 6 again. For example, the spring contact 31 and the limiting member 33 respectively abut against two opposite ends of the atomization core 2 in the thickness direction, and the access opening 3b opens toward the top side. In this way, the spring contact 31 and the limiting member 33 jointly limit movement of the atomization core 2 in the thickness direction, and the two components implement a good fixing function. In addition, during assembly of the atomization core 2, the atomization core 2 may be moved from the top side to the bottom side, and enters the limiting space 3a through the access opening 3b. Therefore, the assembly is simple and fast.

In an aspect, the limiting member 33 is approximately in a plate-like shape, which can increase a contact area between the limiting member 33 and the atomization core 2 and further improve stability of the atomization core 2.

Refer to FIG. 3 and FIG. 6. In an aspect, the limiting member 33 is connected to the stopping member 32, which not only can improve overall stability of the fixing bracket 3, but also can reduce manufacturing difficulty of the fixing bracket 3 to facilitate production.

Refer to FIG. 2 and FIG. 7. In an aspect, the aerosol generating device 100 includes a conductive member 4, and the conductive member 4 is electrically connected to the fixing bracket 3. The conductive member 4 is configured to provide electric energy. In this aspect, the conductive member 4 is electrically connected to the fixing bracket 3, and the fixing bracket 3 is conductive. In this way, the conductive member 4 transmits external electric energy to the atomization core 2 through the fixing bracket 3, and the atomization core 2 can heat the aerosol generating substrate to generate an aerosol when energized. In addition, no additional conductive structure, such as a wire, is required for transmitting electric energy, thereby reducing a number of parts and reducing production costs and assembly difficulty.

A specific material of the fixing bracket 3 is not limited. For example, the fixing bracket 3 may be made of a metal material, which provides good electrical conductivity. For example, the metal material may be brass, SUS430 stainless steel, or 1018 stainless steel.

In an aspect, the conductive member 4 may be a conductive pin.

In an aspect, the conductive member 4 is in welded connection with the fixing bracket 3, which can improve connection stability between the conductive member 4 and the fixing bracket 3. In addition, the welded connection can improve electrical conductivity between the conductive member 4 and the fixing bracket 3 to some extent, thereby improving operational reliability of the aerosol generating device.

Refer to FIG. 4 to FIG. 6. In an aspect, two conductive members 4 and two fixing brackets 3 are provided, the two conductive members 4 are electrically connected to the two fixing brackets 3, respectively, and the atomization core 2 is located in the limiting space 3a of the two fixing brackets 3. The two conductive members 4 are positively charged and negatively charged, respectively, and the two fixing brackets 3 are charged with opposite polarities.

Refer to FIG. 4. For example, the two conductive members 4 are electrically connected to two fixing brackets 3, respectively, and the two conductive members 4 are disposed at an interval in the first direction. That is, the two fixing brackets 3 are spaced apart in the first direction, and both ends of the atomization core 2 in the first direction are respectively located in the limiting space 3a of the two fixing brackets 3. In this way, the end portion of the atomization core 2 is accommodated in the limiting space 3a, which not only can improve stability of the atomization core 2, but also can prevent the end portion of the atomization core 2 from being damaged due to collision with another part. In addition, the two fixing brackets 3 are not in contact, no additional power-on circuit is formed between the two fixing brackets 3, and a current cannot be directly transmitted through the two fixing brackets 3, thereby preventing the occurrence of a short circuit and avoiding damage to the aerosol generating device 100.

Refer to FIG. 4. In an aspect, one stopping member 32 is provided for each of the two fixing brackets 3, and the stopping members 32 of the two fixing brackets 3 respectively abut against both ends of the atomization core 2 in the first direction.

Refer to FIG. 4 and FIG. 5. In an aspect, the atomization core 2 includes a body 21 and a heating element 22, at least a part of the heating element 22 is disposed on the surface of the body 21, and the spring contact 31 abuts against the heating element 22. For example, the body 21 has an atomization surface, the heating element 22 is disposed on the atomization surface, the body 21 can guide the aerosol generating substrate to the atomization surface, and the heating element 22 is configured to heat the aerosol generating substrate on the atomization surface to generate an aerosol.

Specifically, the spring contact 31 is in an interference fit with the heating element 22, which enables the spring contact 31 to be in stable contact with the heating element 22. The spring contact 31 has good electrical conductivity, the conductive member 4 can transmit electrical energy to the heating element 22 through the spring contact 31, and good stability of the electrical energy is maintained during transmission. The heating element 22 can heat the aerosol generating substrate to generate an aerosol when energized, thereby ensuring operational reliability of the aerosol generating device 100.

That at least a part of the heating element 22 is disposed on the surface of the body 21 means that: a part of the heating element 22 may be disposed on the surface of the body 21, or the entire heating element 22 may be disposed on the surface of the body 21.

The body 21 may be a porous structure. The porous structure refers to a structure having a plurality of pores therein that communicate with each other and that communicate with the outer surface of the body 21. The pores of the porous structure facilitate temporary storage of the liquid aerosol generating substrate, and also facilitate flow of the liquid aerosol generating substrate. The pores may have capillarity action, and the capillarity action of the pores guides the aerosol generating substrate to the atomization surface.

The pores of the porous structure may be arranged in a disordered manner. The disordered arrangement means that the pores are randomly generated without a set rule.

The body 21 may be made of a ceramic material. The ceramic material has characteristics of good thermal conductivity uniformity and the like. For example, the body 21 may be made of a porous ceramic material. The porous ceramic material may be formed by performing high-temperature sintering on components such as an aggregate, a binder, and a pore-forming agent.

The heating element 22 may be a heating film, that is, the aerosol generating device 100 generates an aerosol through resistance heating.

Refer to FIG. 4 and FIG. 5. In an aspect, the protrusion 311 abuts against the heating element 22, thereby further improving connection stability between the spring contact 31 and the heating element 22. This ensures uninterrupted transmission of electric energy and operational reliability of the aerosol generating device 100.

Refer to FIG. 8 and FIG. 9. In an aspect, the conductive member 4 and the spring contact 31 jointly define a limiting space 3a, the spring contact 31 and the conductive member 4 respectively abut against two opposite ends of the atomization core 2 in the thickness direction, and at least a part of the atomization core 2 is located in the limiting space 3a. That is, the conductive member 4 is in contact with the atomization core 2, and the conductive member 4 can directly transmit electric energy to the atomization core 2. In this way, the conductive member 4 and the spring contact 31 jointly limit movement of the atomization core 2 in the thickness direction, and the conductive member 4 simultaneously implements an electrical conduction function and a limiting function, which can reduce a number of fixing structures, such as the spring contact 31, while ensuring stability of the atomization core 2, thereby reducing costs. In addition, the conductive member 4 and the spring contact 31 are disposed at an interval in the thickness direction. The conductive member 4 is not in contact with the spring contact 31, and electrical energy is not transmitted to the spring contact 31, which can prevent a short circuit and avoid burnout of the aerosol generating device 100.

Refer to FIG. 8 and FIG. 9. In an aspect, two fixing brackets 3 are provided, the two fixing brackets 3 are disposed at an interval, the conductive member 4 is located between the two fixing brackets 3 to define two limiting spaces 3a, and at least one atomization core 2 is disposed in each limiting space 3a.

Refer to FIG. 8 and FIG. 9. For example, the conductive member 4 and the two fixing brackets 3 are disposed at intervals in the thickness direction, the conductive member 4 and spring contacts 31 of the two fixing brackets 3 define two limiting spaces 3a that are distributed at an interval in the thickness direction, and one atomization core 2 is disposed in each limiting space 3a. In this way, through the fitting between the conductive member 4 and the fixing brackets 3, at least two atomization cores 2 can be fixed simultaneously, and the conductive member 4, the fixing brackets 3, and the atomization cores 2 form a compact structure with good stability. In addition, a contact area between the atomization cores and the buffer structure 11 can be increased by increasing a number of atomization cores 2, thereby improving atomization efficiency. Moreover, the conductive member 4 can simultaneously fix the at least two atomization cores 2, thereby reducing a number of parts required for fixing each atomization core 2, and reducing assembly difficulty.

For example, in an aspect, two, three, or four atomization cores 2 are disposed in each limiting space 3a. For example, two atomization cores 2 are disposed in each limiting space 3a, and the two atomization cores 2 are arranged side by side in the first direction.

Refer to FIG. 7. In an aspect, the sides, away from the conductive member 4, of the two atomization cores 2 abut against the buffer structure 11. In this way, in a process in which the user uses the aerosol generating device 100, the two atomization cores 2 can simultaneously heat and atomize the aerosol generating substrate to generate an aerosol, thereby improving atomization efficiency. In addition, the user can inhale an aerosol with a richer flavor, thereby enhancing user experience.

Refer to FIG. 9. In an aspect, the conductive member 4 abuts against the heating element 22. Specifically, the conductive member 4 is in an interference fit with the heating element 22, which enables the conductive member 4 to be in stable contact with the heating element 22. In this way, good stability of electric energy is maintained during transmission, thereby ensuring operational reliability of the aerosol generating device 100.

Refer to FIG. 8 and FIG. 9. In an aspect, the aerosol generating device 100 includes an insulating member 5, and the atomization core 2 is supported above the insulating member 5.

The insulating member 5 implements an insulation protection function, to prevent current in the atomization core 2 from being transmitted to a surrounding environment, thereby avoiding occurrence of a short circuit or the like. The insulating member 5 further supports the atomization core 2. During assembly, the atomization core 2 is disposed on a supporting surface of the insulating member 5. Therefore, the assembly is simple and assembly difficulty is low.

Refer to FIG. 9. For example, two atomization cores 2 are respectively supported on two supporting surfaces of the insulating member 5, and the two supporting surfaces are flush with each other. That is, the heights of the two atomization cores 2 are the same. In this way, the two atomization cores 2 can be supported above the insulating member 5 more stably, thereby ensuring operational reliability of the aerosol generating device 100.

It may be understood that the insulating member 5 is made of an insulating material with good high-temperature resistance, to meet requirements of a high-temperature and insulation operating environment. For example, the insulating member 5 may be made of a plastic material.

Refer to FIG. 9. In an aspect, the fixing bracket 3 is supported on the top side of the insulating member 5. In this way, the insulating member 5 also supports the fixing bracket 3, so that a part required for supporting the fixing bracket 3 can be omitted, and costs can be reduced.

Refer to FIG. 8. In an aspect, the insulating member 5 includes two limiting posts 51, and the two limiting posts 51 respectively abut against both ends of the atomization core 2 in the first direction. In this way, the two limiting posts 51 can limit movement of the atomization core 2 in the first direction, so that the atomization core 2 can be further stably supported on the insulating member 5.

Refer to FIG. 8. In an aspect, the fixing bracket 3 includes two stopping members 32, and the side, away from the atomization core 2, of each limiting post 51 abuts against a corresponding stopping member 32. Refer to FIG. 8 again. For example, spaces between the conductive member 4 and the two stopping members 32 are limiting spaces 3a, and the two limiting posts 51 are located in the limiting spaces 3a. In this way, the limiting spaces 3a limit the limiting posts 51, to avoid bending and deformation of the limiting posts 51, which prevents shifting and displacement of the atomization core 2, and further improves stability of the atomization core 2.

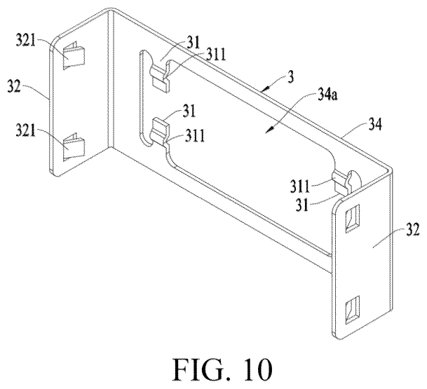

Refer to FIG. 8 and FIG. 10. In an aspect, the stopping member 32 is formed with a limiting portion 321, and the limiting portion 321 extends into the limiting space 3a and abuts against the side, facing the conductive member 4, of the limiting post 51. In this way, connection stability between the fixing bracket 3 and the insulating member 5 can be enhanced through the limiting portion 321, to prevent the limiting post 51 from being separated from the limiting space 3a, thereby better fixing the atomization core 2.

Refer to FIG. 9 and FIG. 10. In an aspect, the fixing bracket 3 includes a carrier plate 34, the carrier plate 34 is located on the side, away from the conductive member 4, of the atomization core 2, the carrier plate 34 forms an avoidance notch 34a, the spring contact 31 is connected to the carrier plate 34, and at least a part of the spring contact 31 is located in the avoidance notch 34a.

In this aspect, the conductive member 4, the two stopping members 32, and the carrier plate 34 jointly define a limiting space 3a, the avoidance notch 34a communicates with the limiting space 3a, and a part of the buffer structure 11 is located on the side, away from the conductive member 4, of the atomization core 2. In this way, the aerosol generating substrate can enter the atomization core 2 through the avoidance notch 34a.

Refer to FIG. 9 again. For example, the conductive member 4 and the spring contact 31 are respectively located at both ends of the atomization core 2 in the thickness direction. In this way, the conductive member 4 and the spring contact 31 respectively apply opposite forces to the atomization core 2 in the thickness direction, which can enhance stability of the atomization core 2.

Refer to FIG. 9 and FIG. 10. In an aspect, the fixing bracket 3 includes at least two spring contacts 31, and the at least two spring contacts 31 are disposed at an interval in a circumferential direction of the avoidance notch 34a. A specific number of spring contacts 31 is not limited, and may be, for example, two, three, or four. Refer to FIG. 9 and FIG. 10 again. For example, the avoidance notch 34a is approximately rectangular, four spring contacts 31 are provided, and the four spring contacts 31 are respectively located at four vertexes of the avoidance notch 34a.

Refer to FIG. 1, FIG. 2, and FIG. 7. In an aspect, the aerosol generating device 100 includes a housing assembly 6, the housing assembly 6 forms an inhalation channel 6a, the liquid storage assembly 1 forms an atomization channel 1b, the inhalation channel 6a communicates with the atomization channel 1b, and the atomization channel 1b and the inhalation channel 6a are both configured to deliver an aerosol.

For example, the housing assembly 6 is formed with an accommodating cavity, and the liquid storage assembly 1 is disposed in the accommodating cavity. The housing assembly 6 protects and seals the liquid storage assembly 1, to prevent the aerosol generating substrate from seeping out. The outer surface of the housing assembly 6 may be a smooth curved surface, which provides an attractive appearance, and is further convenient for the user to hold the aerosol generating device 100.

Refer to FIG. 2 and FIG. 7 again. The buffer structure 11 forms the atomization channel 1b, and at least a part of the atomization core 2 is located in the atomization channel 1b. In this way, an aerosol generated by the atomization core 2 can smoothly flow through the atomization channel 1b and the inhalation channel 6a for user inhalation.

Refer to FIG. 1, FIG. 2, and FIG. 7. In an aspect, the housing assembly 6 includes a mouthpiece 61, the mouthpiece 61 forms the inhalation channel 6a, and the user may inhale an aerosol through the mouthpiece 61. A specific material of the mouthpiece 61 is not limited. For example, the mouthpiece 61 may be made of a plastic material.

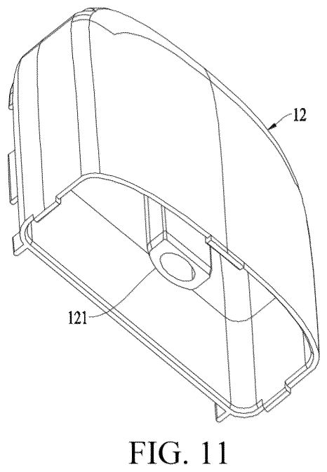

Refer to FIG. 2 and FIG. 11. In an aspect the liquid storage assembly 1 includes a liquid storage housing 12. The liquid storage housing 12 is formed with a liquid storage tube 121, at least a part of the liquid storage tube 121 extends into the atomization channel 1b, the liquid storage tube 121 communicates with the atomization channel 1b, and the circumferential surface of the liquid storage tube 121 abuts against the wall surface of the atomization channel 1b. In this way, the liquid storage tube 121 supports the atomization channel 1b, to prevent the buffer structure 11 from contracting after the aerosol generating substrate in the buffer structure 11 is decreased, thereby avoiding blockage of the atomization channel 1b and ensuring flow of an aerosol.

Refer to FIG. 2 and FIG. 7. In an aspect, the liquid storage assembly 1 includes two sealing bases 13, the two sealing bases 13 are disposed on both sides of the liquid storage housing 12 in a top-bottom direction, and the liquid storage housing 12 and the two sealing bases 13 jointly define the liquid storage cavity 1a. In this way, the sealing bases 13 implement a good sealing function, to prevent the aerosol generating substrate from seeping out of the liquid storage cavity 1a.

A specific material of the sealing base 13 is not limited. For example, the sealing base may be made of a flexible material such as a silicone material.

Refer to FIG. 2 and FIG. 7. In an aspect, the conductive member 4 penetrates through the sealing base 13 on the bottom side. Specifically, the conductive member 4 is in an interference fit with the sealing base 13 on the bottom side. In this way, the sealing base 13 not only can fix the conductive member 4, to reduce a number of parts required for fixing the conductive member 4, but also can prevent the aerosol generating substrate from seeping out from a gap between the conductive member 4 and the sealing base 13.

In an aspect, the sealing base 13 on the bottom side is formed with a vent channel, and the liquid storage cavity 1a communicates with the atmosphere through the vent channel.

It should be noted that the air pressure in the liquid storage cavity 1a is less than the atmospheric pressure, and the air pressure in the liquid storage cavity 1a is a negative pressure relative to the atmospheric pressure. That is, the vent channel is a one-way channel. In this way, the aerosol generating substrate cannot seep out from the liquid storage cavity 1a through the vent channel, and external air can enter the liquid storage cavity 1a through the vent channel.

For example, in a process in which the user inhales an aerosol, the aerosol generating substrate in the buffer structure 11 is gradually reduced, and a volume of an empty cavity is gradually increased, the air pressure in the liquid storage cavity 1a gradually decreases, and external air can enter the liquid storage cavity 1a through the vent channel, to compensate for the air pressure in the liquid storage cavity 1a, so as to maintain air pressure stability of the liquid storage cavity 1a.

Refer to FIG. 2 and FIG. 7. In an aspect, the aerosol generating device 100 includes a cell assembly 7, the cell assembly 7 is disposed in the accommodating cavity, and the conductive member 4 is electrically connected to the cell assembly 7. The cell assembly 7 refers to a device capable of storing electric energy. The electric energy of the cell assembly 7 can be transmitted to the atomization core 2 through the conductive member 4. In this way, the cell assembly 7 can ensure endurance performance of the aerosol generating device 100, to allow the user to inhale an aerosol at any time, thereby improving user experience. In addition, the housing assembly 6 can prevent the cell assembly 7 from being in contact with an external structure, thereby providing good protection for the cell assembly 7.

For example, the cell assembly 7 includes a secondary battery. The secondary battery refers to a battery that can be recharged after being discharged, to reactivate active materials for continued use. In this way, the user can recharge the secondary battery, thereby repeatedly using the cell assembly 7, and reducing costs.

In the descriptions of this specification, descriptions of reference terms such as “in an aspect”, “in an aspect”, “in some other aspects”, and “for example” mean that specific features, structures, materials, or characteristics described with reference to this aspect or example are included in at least one aspect or example of the aspects of this disclosure. In this specification, the illustrative expressions of the above terms do not necessarily refer to the same aspect or example. Furthermore, the described specific features, structures, materials, or characteristics may be combined in proper manners in any one or more aspects or examples. In addition, without mutual contradiction, a person skilled in the art may combine different aspects or examples described in this specification, as well as features of different aspects or examples.

Various aspects/implementations of this disclosure can be combined with each other provided that no contradiction occurs. The above contents are merely preferred aspects of this disclosure and are not used for limiting this disclosure, and a person skilled in the art may make various modification and changes to this disclosure. Any modification, equivalent replacement, and improvement made without departing from the spirit and principle of this disclosure shall fall within the scope of protection of this disclosure.

What is claimed is:

1. An aerosol generating device comprising:
a liquid storage assembly including a liquid storage cavity, wherein the liquid storage cavity is configured to store an aerosol generating substrate;
an atomization core atomizing the aerosol generating substrate to generate an aerosol; and
a fixing bracket including a spring contact, a thickness direction of the atomization core is in stop engagement with the atomization core.

2. The aerosol generating device of claim 1, wherein the spring contact is formed with a protrusion facing the atomization core, and the protrusion abuts against the atomization core.

3. The aerosol generating device of claim 1, wherein the fixing bracket comprises a stopping structure, the stopping structure is in stop engagement with the atomization core, and at least a part of the stopping structure and the spring contact are respectively located on different sides of the atomization core.

4. The aerosol generating device of claim 1 further comprising:
a conductive member, wherein the conductive member is electrically connected to the fixing bracket.

5. The aerosol generating device of claim 1 further comprising:
two conductive members and two fixing brackets, wherein the two conductive members are electrically connected to the two fixing brackets, respectively, and the atomization core is located in a limiting space of the two fixing brackets.

6. The aerosol generating device of claim 1, wherein the atomization core comprises a body and a heating element, at least a part of the heating element is disposed on a surface of the body, and the spring contact abuts against the heating element.

7. The aerosol generating device of claim 1 further comprising:
a conductive member, wherein the conductive member and the spring contact jointly define a limiting space, at least a part of the atomization core is located in the limiting space, and the spring contact and the conductive member respectively abut against two opposite ends of the atomization core in a thickness direction.

8. The aerosol generating device of claim 7 further comprising:
a second fixing bracket, wherein the two fixing brackets are disposed at an interval, the conductive member is located between the two fixing brackets to define the two limiting spaces, and at least one atomization core is disposed in each limiting space.

9. The aerosol generating device of claim 7, wherein the atomization core comprises a body and a heating element, at least a part of the heating element is disposed on a surface of the body, and the conductive member abuts against the heating element.

10. The aerosol generating device of claim 7 further comprising:
an insulating member, wherein the atomization core is supported above the insulating member.
